(19) United States
(12) Patent Application Publication
(10) Pub. No.: US 2013/0058708 A1
(43) Pub. Date: Mar. 7, 2013

(54) JACKET STRUCTURE FOR OFFSHORE CONSTRUCTIONS

(71) Applicant: Henrik Stiesdal, Odense C. (DK)

(72) Inventor: Henrik Stiesdal, Odense C. (DK)

(21) Appl. No.: 13/697,852

(22) PCT Filed: Sep. 15, 2010
(86) PCT No.: PCT/EP2010/063546

§ 371 Date: Nov. 14, 2012

(30) Foreign Application Priority Data
May 25, 2010 (EP) 10163754.4

(51) Int. Cl. F16B 7/00

(52) U.S. Cl. 403/230

(57) ABSTRACT

Jacket structure for offshore constructions, particularly jacket structure for offshore wind turbines, including a number of first and second profiles, whereby the first profiles include rods in axial alignment and the second profiles include rods in an angled alignment relative to the first profiles, and a number of node members providing a connection site for the second profiles, wherein the node members are connected to the first profiles and/or at least one adapter profile connected to at least one first profile of the jacket structure via a bolted connection.

### CROSS REFERENCE TO RELATED APPLICATIONS

This application is the US National Stage of International Application No. PCT/EP2010/063546, filed Sep. 15, 2010 and claims the benefit thereof. The International Application claims the benefits of European application No. 10163754.4 filed May 25, 2010. All of the applications are incorporated by reference herein in their entirety.

### FIELD OF INVENTION

The invention relates to a jacket structure for offshore constructions, particularly a jacket structure for offshore wind turbines, comprising a number of profiles in axial or angled alignment and a number of node members.

### BACKGROUND OF INVENTION

Offshore constructions for structures to be installed in the sea are usually necessary in particular for offshore wind power plants, that is offshore wind turbines and represent a constructive challenge as the respective structure has to be erected on the seabed by means of an appropriate foundation.

A number of different types of foundations such as monopole-, tripile-, tripod- or gravity-foundations are known from prior art.

Aside, jacket structures are well-known since they are constructively simple, show good mechanical properties, particularly due to a high stiffness-to-material-use ratio, and thus, are adapted to be erected on sites with high wave-loads. Besides, jacket structures are comparatively cost-effective.

EP 2 067 914 A1 discloses a jacket structure comprising a number of rod-profiles in axial or angled alignment and a number of node members, whereby a connection of the rod-profiles and the node members is achieved by welding.

### SUMMARY OF INVENTION

Yet, welding represents a comparatively complex connecting method for establishing a stable connection of the node members with respective parts of the jacket structure, that is foremost the profiles of the jacket structure. Accordingly, the used materials must be weldable, which is deemed as a restriction in the selection of possible materials for the jacket structure. Altogether, welded joints are fairly complex in planning and realisation.

Hence, it is the object of the invention to provide a jacket structure for offshore constructions with an improved connecting principle concerning the node members.

This is achieved by a jacket structure for offshore constructions as described above, wherein the node members are connected to the jacket structure and/or at least one adapter profile connected to at least one first profile of the jacket structure by means of a bolted connection.

Hence, the present invention uses bolted joints instead of welded joints for providing a connection of the node members with respective first profiles of the jacket structure, that is respective axially extending rods and/or the at least one adapter profile connected to at least one first profile of the jacket structure. Bolted-connections are detachable and generally represent a constructively simple and quick way to provide a mechanically stable connection or installation of the jacket structure as a whole. As a result, the jacket structure may be easily and fast erected on a respective site. The bolted connections may be improved by the use of threads provided with the connected parts so that connecting means such as bolts or the like may be more stably engaged.

Additionally or alternatively, it is possible that the jacket structure comprises at least one adapter profile connected to at least one first profile of the jacket structure, whereby at least one node member is connected to the adapter profile. In such a manner, the adapter profile and the node member preferably built a pre-assembled component, comprising a bolted connection of the node member with the adapter profile. Hence, the adapter profile may be deemed as a separate part which serves to establish a connection between the node member and at least one first profile of the jacket structure.

Consequently, the adapter profile comprises at least two different connection portions, that is one for connecting with the node member by means of the inventive bolted joint and at least a second one for connecting with an adjacently axially disposed first profile of the jacket structure, whereby in the latter case not only bolted connections may be used, but different types of connections such as welded joints for instance are applicable as well.

In such a manner, the inventive jacket structure is easy to mantle, that is can be mantled “on site”. Likewise, load calculations are reduced in complexity as well as costly inspections of welded joints are not necessary with the inventive jacket structure providing an easy, cost-effective connecting principle. Further, the inventive jacket structure allows a high degree of flexibility concerning diameters, wall thicknesses, angles, etc. of the respective profiles and/or node members.

The first and second profiles of the jacket structure are usually at least partially hollow or massive rods. The cross-section of the first and second profiles and the node members respectively is preferably round or elliptical, yet other shapes are feasible as well. All parts of the jacket structure are built of materials which are capable for the use in offshore-applications and particularly comprise good mechanical and anti-corrosive properties. An appropriate material may be stainless steel for instance. Anti-corrosive coatings or varnishes may be applied to the surface of the parts of the jacket structure.

Preferably, the node member comprises a base plate and at least one connecting member extending off the base plate for connecting with a second profile.

Hence, the node member essentially comprises two different connecting portions, whereby the base plate is related to the axial first profiles or the adapter profile respectively and the connecting member is related to a respective angled second profile. The base plate and the connecting member are stably, preferably non-detachably connected with each other. Thus, the base plate and the connecting member may be integrally formed or represent separate stably joint components, whereby a firm connection may be attained by welding or the like for instance.

In a further embodiment of the invention the base plate comprises a connecting portion for connecting the node member with a first profile or the adapter profile. In such a manner, a defined connection of the node member and a first profile or an adapter profile of the jacket structure is attainable by means of the connecting portion which is allocated to the base plate of the node member.

Thereby, it is preferred that the connecting portion of the node member comprises a number of bores, whereby bolts penetrate through the bores thereby, connecting the node member to the first profile or the adapter profile. Thus, a bolted connection of the node member is achievable by bolts engaging through the bores or through holes disposed within the base plate and further into corresponding connecting portions provided with the first profiles or adapter profiles respectively. Threads may be applicable, that is bores and bolts may be provided with corresponding threads at their respective diameters which increases the strength of the bolted joint.

The bores are favourably circumferentially disposed at the borders of the base plate. This arrangement of the bores provides a good stability of the inventive bolted connection. However, the bores may additionally or alternatively be disposed at different sites of the base plate in exceptional cases. The concrete number and arrangement of the bores may differ and depends mainly on the constructive design and load of the inventive jacket structure.

It is possible, that at least one additional connecting member extends off the connecting member. Thereby, the number of potentially connectable second profiles to be connected with the node member may be increased by means of a branched structure of the connecting member. It is understood, that the joint between the connecting member and the respective at least one further connecting member branching thereof is mechanically stable, whereby preferably an integral design of the connecting member with the respective further connecting members is in favour. Thereby, welded joints or the like are applicable for instance.

Aside, the invention relates to a node arrangement for a jacket structure as described before comprising at least one node member being connected to an adapter profile by means of a bolted connection, whereby the adapter profile is connectable or connected to a first profile of the jacket structure. The node arrangement essentially represents a component that is ready to be connected with first profiles of the jacket structure by means of the adapter profile and further, second profiles of the jacket structure by means of the node member as will be described later on. The bolted connection between the node member and the adapter profile contributes to a fast and firm connection of the node member with the adapter profile.

The node member preferably comprises a base plate and at least one connecting member extending off the base plate. Thereby, the connecting member may provide a connection with a second profile that is a rod in an angled alignment with respect to the axial alignment of the first profiles. In other words, the base plate is related to axial extending profiles and the connecting member is related to angled extending profiles of the jacket structure.

It is preferred, when the base plate comprises a connecting portion. The connecting portion is adapted to provide a proper connection of the base plate with the adapter profile.

In such a manner, the connecting portion may comprise a number of bores, whereby each bore is adapted to accommodate a bolt. Thus, the connection of the base plate of the node member and the adapter profile may be attained by bolts penetrating through the bores into appropriate connecting portions of the adapter profile. If need be, the bores and bolts may be provided with corresponding threads.

The bores are preferably circumferentially disposed at the boarders of the base plate. Of course, other arrangements of the bores are applicable as well.

Further, it is possible that at least one additional connecting member extends off the connecting member. In such a manner, the number of possibly attached second profiles may be increased with respect to a single node arrangement.

### BRIEF DESCRIPTION OF THE DRAWINGS

In the following the invention is described in detail as reference is made of the figures, whereby

FIG. 1 shows a principle cut-out view of a jacket structure according to a first exemplary embodiment of the invention;

FIG. 2 shows a principle cut-out view of a node arrangement according to a second exemplary embodiment of the invention;

FIG. 3 shows a principle cut-out view of a node arrangement according to a third exemplary embodiment of the invention;

FIG. 4 shows a principle cut-out view of a node arrangement according to a fourth exemplary embodiment of the invention; and

FIG. 5 shows a principle cut-out view of a jacket structure according to a second exemplary embodiment of the invention.

### DETAILED DESCRIPTION OF INVENTION

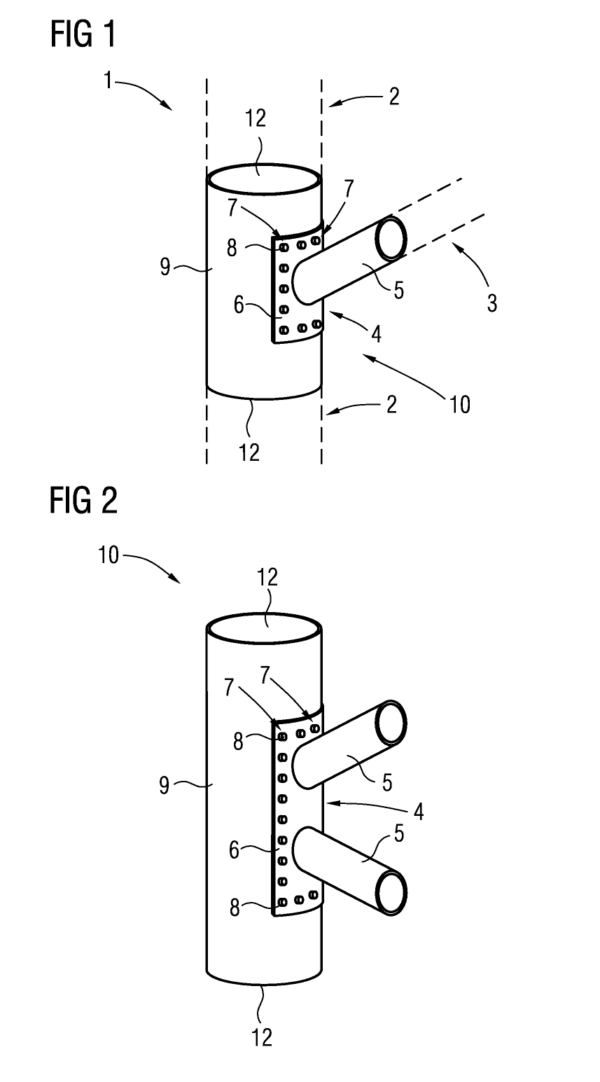

FIG. 1 shows a principle cut-out view of a jacket structure 1 according to a first exemplary embodiment of the invention, whereby only essential parts are depicted, that is FIG. 1 contains only a representative part of the inventive jacket structure 1. The jacket structure 1 comprises first and second profiles 2, 3 (dotted) in the shape of axial extending steel rods (first profile 2) and in the shape of steel rods in an angled alignment (second profile 3) relative to a first profile 2. The jacket structure 1 further comprises a number of node members 4 in a regular arrangement, whereby FIG. 1 shows only one representative example. The jacket structure 1 is preferably used for offshore wind turbines.

As is discernible from FIG. 1, the node members 4 provide a connection site for the second profiles 3 by means of the connecting member 5 extending off the base plate 6 both representing the essential parts of the node member 4. The node member 4 comprises a respective connecting portion in the shape of circumferentially distributed bores 7 provided with the base plate 6. Bolts 8 engage through the bores 7 so as to engage in respective openings of an axially extending adapter profile 9. Hence, the node member 4, that is the base plate 6 and the adapter profile 9 may be deemed as a pre-assembled component in terms of a node arrangement 10 (cf. FIGS. 2-4).

By means of the inventive bolted connection a simple and fast way to detach or attach the node member 4 to the adapter profile 9 of the jacket structure 1 is achievable, which is particularly of advantage in terms of service and/or repair of the jacket structure 1 or respective parts of it.

FIG. 2 shows an inventive node arrangement 10 according to an exemplary embodiment of the invention. The essential difference of the node arrangement shown in FIG. 2 to the node arrangement shown in FIG. 1 is in that the node member 4 comprises two separate connecting members 5 pointing in different, that is essentially opposite directions. In such a manner, the node arrangement 10 or the node member 4 respectively may be connected with two second profiles 3 of the jacket structure 1.

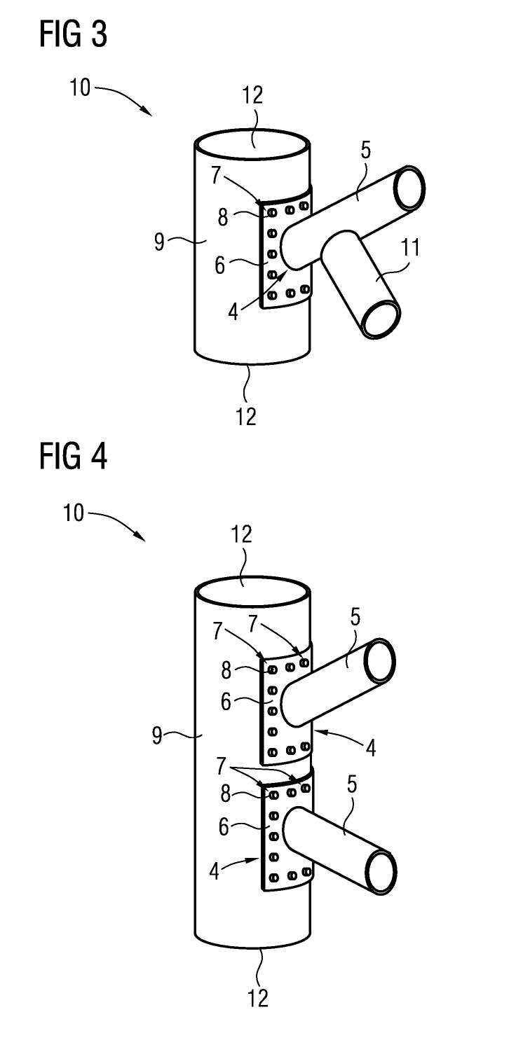

An alternative embodiment of an inventive node arrangement 10 according to a further exemplary embodiment of the invention is shown in FIG. 3. In this case, the node arrangement 10 comprises a branched connecting member 5, that is an additional connecting member 11 extends off the connecting member 5. Hence, the connecting member 5 subdivides into further connecting members, that is with respect to the present embodiment the further connecting member 11. Of course, further connecting members 11 may extend off the connecting member 5. It is understood, that further connecting members may also extend of the connecting member 11. In such a manner, the number of possible arrangements of second profiles 3 to the node arrangement 10, that is the connecting members 5, 11 may be increased.

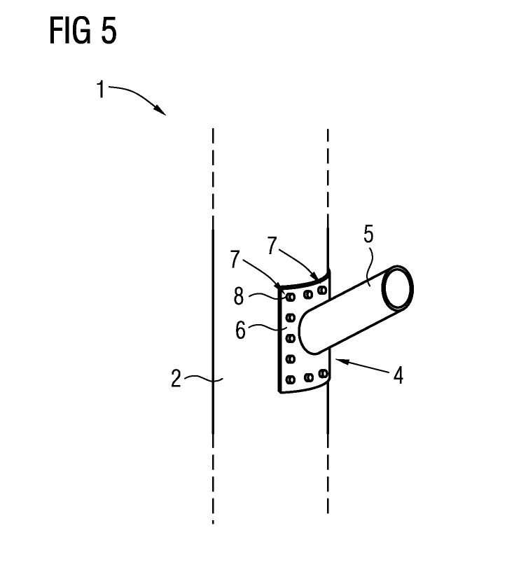

FIG. 4 shows a third embodiment of an inventive node arrangement 10, which is characterized in that the adapter profile 9 is connected with two separate node members 4 as they are depicted in FIG. 1.

In such a manner, the node arrangement 10 may also be connected with two separate second profiles 3 of the inventive jacket structure 1, whereby in the embodiment according to FIG. 4 each node member 4 may be separately connected with a respective second profile 3 (not shown) by means of the respective connecting members 5.

All node arrangements 10, that is the ones depicted in FIGS. 1 to 4 comprise axial connecting portions 12 disposed at the free axial endings of the adapter profile 9, so that the adapter profile 9 and the node arrangement 10 as a whole may be connected to adjacently disposed first profiles 2 of the jacket structure 1 (not shown) by means of welded or bolted joints for instance.

FIG. 5 shows a jacket structure 1 according to a second embodiment of the invention. In this case, the node member 4 is directly joint to a first profile 2 of the jacket structure 1 by means of a bolted connection, that is bolts 8 penetrate through the bores 7 of the base plate 6 of the node member 4 into corresponding openings within the first profile 2. Hence, the embodiment according to FIG. 5 represents a basic principle of the present invention, whereby a bolted connection provides a detachable, yet mechanically stable connection of a node member 4 with the jacket structure 1, that is a first profile 2 of the jacket structure 1.

1-13. (canceled)

14. A node arrangement for a jacket structure having a first profile and a second profile, comprising:
a node member adapted to be connected via a bolted connection to the first profile of the jacket and/or to an adapter profile of the jacket, the node member further adapted to provide a connection site for a second profile of the jacket.

15. The node arrangement according to claim 14,
wherein the node member comprises a base plate, and
wherein a connecting member extends off the base plate to provide the connections site for the second profile

16. The node arrangement according to claim 15,
wherein the base plate comprises a connecting portion for the bolted connection to the first profile and/or adapter profile.

17. The node arrangement according to claim 16,
wherein the connecting portion comprises a plurality of bores, and
wherein each bore is adapted to accommodate a bolt.

18. The node arrangement according to claim 17,
wherein the bores are circumferentially disposed at the boarders of the base plate.

19. The node arrangement according to claim 14,
wherein an additional connecting member extends off the connecting member.

20. A jacket structure for offshore wind turbines, comprising:
a first profile shaped as a rod in axial alignment;
a second profile shaped as a rod in an angled alignment relative to the first profile; and
the node member of the node arrangement of claim 14 is connected via a bolted connection to the first profile and/or an adapter profile which is connected the first profile, the node member providing a connection site for the second profile.

21. The jacket structure according to claim 20,
the node member of the node arrangement of claim 14 is connected via a bolted connection to the first profile and/or an adapter profile which is connected the first profile, the node member providing a connection site for the second profile.

22. The jacket structure according to claim 20,
wherein the adapter profile and the node member build a pre-assembled component.

23. The jacket structure according to claim 22,
wherein the node member comprises a base plate and a connecting member for connecting with a second profile extending off the base plate.

24. The jacket structure according to claim 23,
wherein the base plate comprises a connecting portion for connecting the node member with the first profile or with the adapter profile.

25. The jacket structure according to claim 24,
wherein the connecting portion of the node member comprises a plurality of bores, wherein bolts penetrate through the bores in order to connect the node member to the first profile and/or the adapter profile.

26. The jacket structure according to claim 25,
wherein the bores are circumferentially disposed at the boarders of the base plate.

27. The jacket structure according to claim 20,
wherein an additional connecting member extends off the connecting member.
